(19) United States
(12) Patent Application Publication
(10) Pub. No.: US 2006/0062882 A1
(43) Pub. Date: Mar. 23, 2006

(54) Cornbread stuffing mix and method for preparation

(76) Inventor: David M. Moore, Chicago, IL (US)

Correspondence Address: WELSH & KATZ, LTD, 120 S RIVERSIDE PLAZA, 22ND FLOOR, CHICAGO, IL, 60606, US

(21) Appl. No.: 10/947,802

(22) Filed: Sep. 23, 2004

(51) Int. Cl. A21D 10/00

(52) U.S. Cl. 426/549

(57) ABSTRACT

The subject invention comprises a cornbread dressing and a method for making the cornbread dressing having the steps of: combining a cornbread mix with ingredients, including: eggs, milk, soup, seasonings and vegetables; blending and baking for a short period of time; and stirring the mixture and baking again, to result in a tasty cornbread dressing with acceptable integrity, and texture.

### BACKGROUND OF THE INVENTION

This invention relates to a stuffing mix and, more particularly, to a stuffing mix and method for preparation of a stuffing mix from cornbread.

Stuffing is ordinarily prepared by mixing a farinaceous ingredient, such as bread pieces, with spices and/or vegetables and sufficient water to form a cohesive mass. This mass is then placed in the visceral cavity of poultry or fish and cooked for a prolonged period of time. Cooking in intimate contact with the poultry or sea food is considered necessary if the stuffing is to have the soft texture, flavor and color normally associated with stuffing. Even in the case of packaged stuffing, manufacturers recommend cooking in intimate contact with poultry or fish in order to obtain the proper texture, moisture content and flavor.

Generally speaking, conventional bread stuffing is prepared by obtaining cubes of stale bread, mixing with the requisite vegetables, oil and seasonings and baking. This represents the time honored “from scratch” approach. The form of stuffing currently in vogue utilizes pre-seasoned bread crumbs, which is blended with appropriate amounts of boiling water, and butter to yield the requisite stuffing.

Cornbread stuffing can be different from that of conventional bread stuffing which utilizes stale bread, in that the cornbread crumbs do not generally maintain their integrity during the manipulation necessary to process the stuffing. As a result, cornbread stuffing has not been a popular culinary meal component.

Among the problems encountered by the prior art in producing satisfactory cornbread for stuffing is that when the bread crumbs are added to the other contents of a stuffing mix and hydrated during a cooking process, there is a tendency for the individual crumbs to lose their identity, thus the bread portion of the stuffing mix becomes a pasty mass. The result can be a very pasty and unsatisfactory stuffing. It is thus desirable that the ingredients utilized in the stuffing mix have a strong structure in order to stand up to the processing and cooking conditions to which stuffings are subjected.

Moreover, the current process for preparing cornbread dressing is extremely labor intensive and preparation time can be lengthy. Generally, cornbread is baked first, then mashed into crumbs and mixed with the other seasoning ingredients and finally baked yet again.

### BRIEF SUMMARY OF THE INVENTION

Therefore, a feature of the subject invention is a cornbread stuffing which is easily prepared and which has textural, moisture, and flavor characteristics comparable to traditional baked stuffing.

A further feature of the subject invention is a cornbread stuffing, which has an excellent taste and structural strength, so that the resulting stuffing mix is not pasty.

A yet further feature of the subject invention is a cornbread stuffing in which only a single baking is required.

The above-features of the invention are present in the subject invention which comprises a cornbread dressing and a method for making the cornbread dressing having the steps of:
combining a cornbread mix with ingredients, including: eggs, milk, soup, seasonings and vegetables;
blending and baking for a short period of time; and
stirring the mixture and baking again.
The result is a tasty cornbread dressing with acceptable integrity, and texture.

### DETAILED DESCRIPTION OF THE INVENTION

The process of the subject invention is a one-step process in which the ingredients are blended and partially baked, stirred and then fully baked.

In the process of the subject invention, the principal ingredient is a cornbread mix which is commercially available and generally includes components of cornmeal and wheat flour. An example of one such acceptable cornbread mix is available from Chelsea Milling Company, Chelsea, Mich., as Jiffy Corn Muffin Mix. The vegetables, eggs and soup which are utilized in the subject invention are also commercially available. For purposes of the subject invention, the term “cornbread” refers to bread prepared using mixtures of corn flour or cornmeal and mixtures of these with other flours.

The vegetable and seasoning components of the stuffing mix of this invention may comprise a mixture of condiments, flavorings and precooked hydrated or dehydrated vegetables and/or hydrated or dehydrated fruit. The particular condiments and other ingredients used in this second component will depend on the nature of the meat or fish with which the stuffing is to be served and the flavor desired in the stuffing. Cooked and precooked vegetables which may be used include: rice, potato, and dehydrated onion, green or red peppers, parsley, celery, carrots and the like. Meat flavoring such as chicken seasoning, poultry seasoning, beef, bacon or pork flavoring is added where appropriate. The composition also may include particles of a meat flavored protein analog such as beef, chicken or bacon flavored protein. Hydrated or dehydrated fruit pieces such as hydrated or dehydrated apples, pears, apricots, prunes, raisins and the like may be substituted for all or part of the vegetables present in the stuffing composition. A component may also contain a fat or oil in powdered form, such as encapsulated spray dried butter, animal fat or vegetable fat. Where such an ingredient is present, the amount of fat or oil added separately before the cooking may be correspondingly reduced.

The manner of mixing and heating the ingredients of the subject invention may be in a standard sigma-blade mixer or other mixer or it may be accomplished by an extrusion technique, in extrusion apparatus, as desired.

The cornbread dressing of the subject invention may be prepared through the initial preparation of the vegetables by sautéing them in butter. In a separate bowl, the cornbread mix, egg and milk are combined. The chicken soup and dry seasonings are mixed with the cornbread, egg and milk mixture and blended. The sautéed vegetables are then poured into this mixture and blended. The entire mixture is then partially baked at temperatures from 325-450° F., preferably 375 to 400° F., for 15-30 minutes, removed from the oven, stirred and then baked again at 325-450° F., preferably at 375-400° F., for a further 30-50 minutes. The result is a product having the appearance of a pudding with visible cornbread. This mixture may then be broken apart and eaten as stuffing or delivered to a final destination, such as a restaurant where it may be consumed there. It may also be broken up into a form resembling crumbs or cubes, dehydrated and subsequently marketed for use as a stuffing mix that may be re-hydrated, heated and consumed.

### ILLUSTRATIVE EMBODIMENT

The following specific embodiment will further serve to illustrate the invention, which is not to be limited thereby, the invention being defined in the accompanying claims.

| INGREDIENTS | AMOUNT | |
|---|---|---|
| Cornbread Mix | 16 | oz. |
| Butter or Margarine | 4 | tablespoons |
| Chicken Broth | 1 | can (10 oz.) |
| Cream of Chicken Soup | 1 | can (10 oz.) |
| Green Onion | 1 | bunch |
| Egg | 1 | |
| Milk | ¼ | cup |
| Celery | 4 | stalks |
| Seasoned Salt | ¼ | tablespoon |

| | |
|---|---|
| Black Pepper | to taste |
| Sage | to taste |

### EXAMPLE 1

The stuffing is prepared by slicing and dicing the onions and celery and sautéing them in butter. The cornbread mix, one egg and ¼ cup of milk are combined. One can of chicken broth and one can of cream of chicken soup, in addition to the dry seasonings, are added to the cornbread, egg and milk mixture and blended. The sautéed vegetables are added to this blend and further blended. This mixture is then partially baked at 400° for twenty minutes in a greased pan or Pyrex dish. The baked mixture is removed from the oven, stirred completely and then baked for a further forty minutes or to a desired brownness at 400°. This resulted pudding-like mixture is then stirred again so that it is broken up into a lumpy, semi-dried mixture resembling crumbs or cubes. The flavor, texture and mouth-feel associated with the subject stuffing is similar to that of conventional stuffing.

### EXAMPLE 2

The crumbs or cubes of the above stuffing as prepared in example 1, may then be dehydrated and packaged whereupon in the hands of the consumer, re-hydration will result in a duplication of the results of example 1.

### EXAMPLE 3

| INGREDIENTS | AMOUNT | |
|---|---|---|
| Gizzards and/or turkey necks | 2 | lbs. |
| Green Onion | 1 | bunch |
| White Onion | 1 | large |
| Bell Pepper | 1 | |
| Celery | ½ | stalk |
| Black Pepper | ½ | tsp. |
| Sage | ¼ | tsp. |
| Garlic | 4 | cloves |
| Egg | 1 | |
| Milk | ½ | cup |

| | |
|---|---|
| Season | All to taste |

| CORN BREAD INGREDIENTS | AMOUNT | |
|---|---|---|
| Corn Meal | 2 | cups |
| Flour | ½ | cup |
| Baking Powder | 1 | tsp. |
| Egg | 2 | |
| Milk | ½ | pint |

Mix corn bread ingredients, partially bake separately at 400° F. and set aside. Chop seasonings and separate in half. Boil gizzards and/or turkey necks with half of the chopped seasoning. Boil until gizzards/turkey necks are tender (at least 2 hours), adding water as necessary. Debone and chop or grind. Save broth from boiled gizzards/turkey necks. Brown a small roux (flour and oil or just flour). Saute remaining chopped seasoning lightly. Add gizzards and/or turkey necks and roux to seasoning mix. Cook at 400° F. for 15 minutes. Add broth from boiled gizzards/necks. Cook at 200° f. to boiling for 20 minutes. Add crumbled corn bread beaten with egg and ½ cup milk to gizzards/necks mixture. Pour into square casserole dish and bake for 1 hour at 375° F. The result is a traditional turkey stuffing with good flavor, mouth-feeling and texture.

While the invention has been explained with a detailed description of certain specific embodiments, it is understood that various modifications and substitutions can be made in any of them within the scope of the appended claims which are intended to also include equivalents of such embodiments.

I claim:

1. A method of preparing a cornbread stuffing comprising:
1. combining a cornbread mix with other ingredients to form a mixture;
2. blending and partially baking the mixture;
3. stirring the mixture and breaking the mixture up into discrete portions; and
4. baking, to result in the cornbread stuffing:

2. the method of claim 1, further comprising the step of dehydrating the cornbread stuffing.

3. The method of claim 2, further comprising the step of re-hydrating the dehydrated cornbread stuffing.

4. The method of claim 1, wherein the mixture is baked at 375-400° F. for 20 minutes.

5. The method of claim 1, wherein the broken up mixture is baked at 375-400° F.

6. The method of claim 5, wherein the other ingredients comprise eggs, milk, soup, seasoning and vegetables.

7. The method of claim 6, wherein the steps of blending and partially baking is performed in an extrusion apparatus.
